(19) United States
(12) Patent Application Publication
(10) Pub. No.: US 2015/0111724 A1
(43) Pub. Date: Apr. 23, 2015

(54) VISIBLE LIGHT RESPONSIVE PHOTOCATALYST BY HYDROPHILIC MODIFICATION USING POLYMER MATERIAL AND A METHOD FOR PREPARING THE SAME

(71) Applicant: Research & Business Foundation SUNGKYUNKWAN UNIVERSITY, Suwon-si (KR)

(72) Inventors: Young Dok KIM, Suwon-si (KR); Hyun Ook SEO, Seoul (KR); Kwang Dae KIM, Incheon (KR); Myung Geun JEONG, Seoul (KR); Dae Han KIM, Seoul (KR); Eun Ji PARK, Seoul (KR); Hye Soo YOON, Jeonju-si (KR); Youn Kyoung CHO, Gwangmyeong-si (KR); Bo Ra JEONG, Suwon-si (KR)

(73) Assignee: Research & Business Foundation SUNGKYUNKWAN UNIVERSITY, Suwon-si (KR)

(21) Appl. No.: 14/460,577

(22) Filed: Aug. 15, 2014

(30) Foreign Application Priority Data
Aug. 16, 2013 (KR) 10-2013-0097498
Aug. 4, 2014 (KR) 10-2014-0099781

(51) Int. Cl. B01J 31/38; C02F 1/72; B01J 37/12; C02F 1/32; B01J 37/08; B01D 53/00

(52) U.S. Cl. CPC B01J 31/38; B01J 37/082; B01D 53/007; B01J 37/12; C02F 1/32; C02F 1/725; B01D 2255/802; C02F 2305/10
USPC 502/158; 502/200; 423/210; 210/748.14

(57) ABSTRACT

The present invention relates to a visible light-responsive photocatalyst with an excellent removal efficiency of environmental contaminants, and a method of preparing the same.

According to the present invention, the TiO₂ surface having an increased visible light absorbance due to nitrogen-doping has been modified into a hydrophilic surface using polydimethylsiloxane (PDMS), i.e., a silicon-carbon precursor, and thereby significantly improved the removal efficiency of environmental contaminants under visible light. Additionally, the photocatalyst of the present invention for removing environmental contaminants is applicable to environment-friendly fields such as removal of volatile organic compounds, air purification, wastewater treatment and sterilization, and enables to remove contaminants by being attached to the surfaces of external walls of buildings, construction materials, glass windows, sound-absorbing walls, road facilities, signboards, etc., while preventing damages by sunlight.

### CROSS-REFERENCE TO RELATED APPLICATIONS

This application claims under 35 U.S.C. §119(a) the benefit of Korean Patent Application No. 10-2013-0097498 filed Aug. 16, 2013, and Korean Patent Application No. 10-2014-0099781, filed on Aug. 4, 2014, in the Korean Intellectual Property Office, the disclosures of which are incorporated herein in their entirety by reference for all purposes.

### BACKGROUND

1. Field

The present invention relates to a visible light-responsive photocatalyst with excellent removal efficiency of environmental contaminants, and a method of preparing the same.

2. Description of the Related Art

The generation of environmental contaminants due to industrialization has not only been causing air and water contamination but has also been destroying ecosystems and threatening human health. Accordingly, various researches have been performed on how to capture and remove environmental contaminants. Examples of conventional methods to remove environmental contaminants include adsorption using a substance with high specific surface area, thermal oxidation using a metal or metal oxide catalyst, photochemical degradation using a photocatalyst, etc. The purpose of adsorption using the substance with high specific surface area is not to convert environmental contaminants into non-harmful substances but simply to allow environmental contaminants to be attached thereto and removed. Therefore, there is a risk of secondary contamination due to the detachment of the environmental contaminants and also the used adsorbent can hardly be recycled. In contrast, the thermal oxidation method using a metal or metal oxide catalyst is advantageous in that it can convert environmental contaminants to carbon dioxide and water, which are non-toxic to humans. However, it requires an additional apparatus to supply heat energy because the method should be performed at a high temperature of 200° C. or above, thus limiting the practical applications of the method. Unlike these, the method of photochemical degradation using a photocatalyst has an advantage in that it can convert environmental contaminants into carbon dioxide and water, which are not harmful to humans, via light energy, a clean energy source. Unlike other conventional catalysts, the photocatalyst is considered most advantageous in that it does not require an additional energy source, and enables performing a reaction using light energy at room temperature.

A photocatalyst is capable of sterilizing, performing antibacterial treatment to, and decomposing contaminants in the air and in the water, and has thus been widely applied on glass, tiles, external walls, food, internal walls of factories, metal products, water tanks and building materials, and used for purification of marine contamination, prevention of fungi, blockage of ultraviolet radiation, water purification, air purification, etc.

The material most widely used as a photocatalyst is TiO₂. Since TiO₂ can be used semi-permanently it is advantageous cost-wise. Furthermore, TiO₂ is a safe material that does not harm the environment, and thus does not cause collateral contamination when disposed of.

However, TiO₂ has a bandgap energy of 3.2 eV, equivalent to UV energy, which accounts for 5% of the total solar energy. Accordingly, TiO₂ has a disadvantage in that it has a low absorbance in the visible light region when utilizing solar energy. For utilization of the lights in the visible light region accounting for 70% of the total solar light, modification would be necessary for the improvement of its visible light absorbance. One of the most representative methods of modifying the TiO₂ to improve its visible light absorbance is to dope it with another atom. The doping may be performed by substituting impurity atoms to the TiO₂ lattice to form a new energy level within the bandgap of TiO₂ thereby improving the visible light absorbance.

Examples of the doping methods may include negative-ion doping using halides such as F, Cl⁻, Br⁻, and I⁻ or N³⁻, C⁴⁻, S⁴⁻, etc., and positive-ion doping using metal ions such as Fe³⁺, Mo⁵⁺, and Ru³⁺. Because the positive-ion doping using metal ions confers a low thermal stability to photocatalysts, doping using various non-metal ions is preferred. R. Asahi research group in Japan previously reported that among dopings with various non-metal ions such as C, N, F, and S on TiO₂, N-doping has resulted in the highest visible light absorbance (R. Asahi et. al., Science, 1999).

Studies on the synthesis of nitrogen-doped (N-doped) TiO₂ via various methods have followed since then. For example, Ihara research group in Japan has succeeded in synthesizing N-doped TiO₂ using Ti(SO₄)₂ as a starting material via hydrolysis by the addition of ammonia water, and Wang's research group has synthesized it using Ti(OC₄H₉)₄ as a starting material by adding with ammonia water. Currently, the most well-known nitrogen-doping method is sintering TiO₂ at a high temperature of 500° C. or above while subjecting TiO₂ to a high purity ammonia gas flow. High-temperature sintering of TiO₂ enables the substitution of the oxygen position of TiO₂ with nitrogen ions, to obtain N-doped TiO₂ with high visible light absorbance.

As described above, the N-doped TiO₂ may be prepared by a synthesis in a solution, or by sintering TiO₂ while supplying high purity ammonia gas upon preparation of TiO₂. In previous studies, N-doped TiO₂ was yellow in color and its visible light absorbance was limited to the region of 700 nm or below.

### DISCLOSURE

### Technical Problem

An objective of the present invention is to provide a visible light-responsive photocatalyst with an excellent removal efficiency of environmental contaminants, and a method of preparing the same.

The inventors of the present invention discovered that when a photocatalyst was prepared by coating N-doped TiO₂ with water-repellent polydimethylsiloxane (PDMS) followed by heat-treatment under vacuum, i.e., modifying the coating to be hydrophilic, the resulting photocatalyst was surprisingly rendered to have an improved adsorption capability for environmental contaminants, thus having a synergistic effect for an increase in the removal efficiency of environmental contaminants. Therefore, the present invention is based on the above discovery.

### Technical Solution

In a first embodiment of the present invention, there is provided a photocatalyst modified by forming a water-repellent coating layer on the surface of a nitrogen (N)-doped photocatalyst with hydrophilic surface modification by an organic silicon polymer and subsequent heat-treating under vacuum via an oxidation of an organic silicon polymer, wherein the modified photocatalyst allows water molecules to adsorb on the surface thereof and to react with holes, thereby forming hydroxyl radicals.

Preferably, in the modified photocatalyst, the TiO₂ substituted with nitrogen ions at oxygen position is coated with polydimethylsioxane (PDMS) and heat-treated under vacuum, thereby forming an oxygen vacancy within the TiO₂ lattice, and converting the methyl group of PDMS into a carboxyl group.

In a second embodiment of the present invention, there is provided a method for preparing an N-doped photocatalyst via a gas sintering method using high-purity ammonia gas, wherein the flow rate of ammonia gas is controlled to be at 50 cm³/min or higher, thereby forming the N-doped photocatalyst with an improved light absorbance in the visible light range of 400 nm to 800 nm as well as in the infrared-light region of 800 nm or longer, as compared to that of a N-doped photocatalyst manufactured at 50 cm³/min.

In a third embodiment of the present invention, there is provided an N-doped photocatalyst which is prepared by the method described in the second embodiment of the present invention and has an improved light absorbance.

In a fourth embodiment of the present invention, there is provided a method for preparing a modified photocatalyst with an improved adsorption capacity to organic materials, which is decomposed by the photocatalyst, comprising: a first step of preparing a photocatalyst with a water-repellent surface comprising an organic silicon polymer; and a second step of modifying the water-repellent surface to be a hydrophilic surface via oxidation of the organic silicon polymer by heat treatment of the photocatalyst obtained in the first step under vacuum.

In a fifth embodiment of the present invention, there is provided a photocatalyst modified by the method of the fourth embodiment of the present invention to have an improved adsorption capacity to organic materials, which is decomposed by the photocatalyst.

In a sixth embodiment of the present invention, there is provided a coating composition for solar exposure comprising the photocatalyst of the present invention.

In a seventh embodiment of the present invention, there is provided a formed body for solar exposure comprising the photocatalyst according to the present invention.

In an eighth embodiment of the present invention, there is provided a method for removing organic contaminants using the photocatalyst of the present invention.

In a ninth embodiment of the present invention, there is provided a method for preparing purified water comprising a step of removing contaminants in the water using the photocatalyst of the present invention.

The present invention is described in greater detail below.

Hereafter, the present invention is explained in detail.

A photocatalyst is a catalyst that affects the reaction rate of a particular reaction when exposed to light. For example, the photocatalyst may be a semiconductor material capable of promoting a catalytic reaction (oxidation, reduction) using light as an energy source.

The principle behind photochemical decomposition by a photocatalyst is as follows. When a photocatalyst is exposed to light with energy greater than the bandgap energy, electrons and holes are generated, and the electrons in turn react with oxygen, thereby generating superoxide anions. Additionally, the holes react with water molecules present in air and generate hydroxyl radicals. Here, the thus-generated hydroxyl radicals have a strong oxidizing power and thus oxidize organic contaminants into water and carbon dioxide.

Therefore, the adsorption of water molecules affects the activity of the photocatalyst. According to the mechanism of the photocatalyst, water molecules adsorb to the surface of the photocatalyst and then react with holes, thereby forming hydroxyl radicals, and the thus-formed hydroxyl radicals can oxidize the environmental contaminants.

The modified photocatalyst according to the first embodiment of the present invention is characterized in that, in order to improve not only the adsorption capability of organic materials, i.e., the analytes to be decomposed, but also the adsorption capability of water molecules to the surface thereof, a water-repellent coating layer is formed on the surface of an N-doped photocatalyst with an organic silicon polymer followed by heat treatment under vacuum, thereby modifying the water-repellent surface to be a hydrophilic surface via oxidation of the organic silicon polymer.

### <Hydrophilic Surface Modification Using a Polymer Substance for Improving the Adsorption Efficiency of a Photocatalyst to Analytes to be Decomposed>

The inventors of the present invention have discovered that, when an N-doped photocatalyst surface was modified from a water-repellent surface to a hydrophilic surface via oxidation of an organic silicon polymer by heat treatment under vacuum after forming a water-repellent coating layer on the surface of the N-doped photocatalyst with an organic silicon polymer, the resulting hydrophilic surface increased the adsorption capacity to water molecules, thus generating hydroxyl radicals upon light irradiation, thereby improving the activities of a given photocatalyst. Additionally, from the viewpoint of adsorption of organic contaminants in dark conditions, the inventors have also found that the hydrophilic surface modification considerably enhanced the adsorption capacity to organic contaminants, for example methyleneblue, thereby resulting in an increase of the decomposing activity of a given photocatalyst (Experimental Example 1).

Also, from the viewpoint of adsorption of organic contaminants in dark conditions, the inventors have found that the adsorption capacity to organic contaminants was enhanced due to the N-doping, and thus the N-doping and the hydrophilic surface modification showed synergetic effect on the enhancement of the adsorption capacity to organic contaminants (Experimental Example 1).

<Increase of the Visible Light Absorbance of TiO₂ by Forming Oxygen Vacancies within the TiO₂ Lattice Using a Polymer Material>

The most representative method of improving the visible light absorbance of TiO₂ is to dope TiO₂ with another atom. In addition, the formation of oxygen vacancies within the TiO₂ lattice has been known to increase the visible light absorbance of TiO₂. In the previous studies, plasma treatment has mostly been used to form oxygen vacancies within the TiO₂ lattice.

In the present invention, unlike in conventional methods, TiO₂ was heat-treated along with a polymer substance at high temperature under vacuum, thereby forming oxygen vacancies within the TiO₂ lattice. It is speculated that when the methyl group in PDMS, a polymer, is oxidized into a carbonyl group at high temperature under vacuum, the oxidation of the methyl group is achieved by using oxygen within the TiO₂ lattice due to lack of additional source for oxygen supply. Additionally, via diffuse reflection spectrum, it was also found that the formation of oxygen vacancies within the TiO₂ lattice increases the visible light absorbance of TiO₂.

<Method of Preparing N-Doped TiO₂ with an Improved Light Absorbance Over the Entire Visible Light Region>

Since the release of the report by R. Asahi research group in Japan confirming that the highest visible light absorbance was provided by the N-doped TiO₂ among various non-metal-doped TiO₂, various research efforts have been focused on the synthesis of N-doped TiO₂. For example, Ihara research group in Japan has succeeded in synthesizing N-doped TiO₂ using Ti(SO₄)₂ as a starting material via hydrolysis by the addition of ammonia water, and Wang's research group has synthesized it using Ti(OC₄H₉)₄ as a starting material by the addition of ammonia water. As described above, the N-doped TiO₂ may be prepared by a synthesis in a solution, or by sintering TiO₂ while supplying high purity ammonia gas upon preparation of TiO₂. In previous studies, N-doped TiO₂ was yellow in color and its visible light absorbance was limited to the region of 700 nm or below.

However, in preparing N-doped TiO₂ by a gas sintering method using high-purity ammonia gas according to the present invention, when the flow rate of ammonia gas was adjusted to 50 cm³/min or higher, the resulting N-doped TiO₂ not only had an improved light absorbance over the entire visible light region (400 nm-800 nm) but also exhibited absorption in an infrared region of 800 nm or longer and also took on a dark blue color.

Specifically, it was confirmed that when white TiO₂ powder was subjected to an ammonia gas flow at a rate of 50 cm³/min it turned to yellow, and as the flow rate increased to 100 cm³/min or 200 cm³/min, the color of the TiO₂ powder turned to a darker green (FIG. 3B). Additionally, based on a diffuse spectrum depicting the visible light absorbance, it was confirmed that the highest visible light absorbance was achieved at a flow rate of 200 cm³/min (FIG. 3A). Additionally, it was also confirmed that the N-doping of the present invention increases the visible light absorbance of TiO₂ in all visible light regions from 400 nm to 800 nm (FIG. 3A).

Furthermore, it was confirmed that both the increase in the visible light absorbance due to N-doping and the increase in adsorption rate to organic contaminants due to hydrophilic surface modification contributed to a considerable increase in the decomposing activity of the photocatalyst (Experimental Example 1). In particular, it was confirmed that N-doping considerably improved the efficiency of the photocatalyst by increasing the visible light absorbance and the hydrophilic surface modification considerably increased the amount of organic contaminants adsorbed thereto, and thus the photocatalyst's capability to remove organic contaminants was considerably improved as a result of the synergy thereof.

The photocatalyst before modification to be used in the present invention is not particularly limited and any material in which electrons (e⁻) can be excited from a valence band to a conduction band upon light irradiation may be used. The light absorbed by the photocatalyst before modification may be visible light and/or UV light, but is not limited thereto.

Non-limiting examples of the photocatalyst before modification may include metals, semiconductors, alloys, and a combination thereof. Currently, TiO₂ is the most frequently used photocatalyst, and in addition, ZnO, ZrO₂, WO₃, perovskite-type composite metal oxide, etc., may be used as a photocatalyst as well.

Non-limiting examples of the photocatalyst before modification having UV absorbing activity may include TiO₂, B/Ti oxide, CaTiO₃, SrTiO₃, SrTiO₃, Sr₃Ti₂O₇, Sr₄Ti₃O₁₀, K₂La₂Ti₃O₁₀, Rb₂La₂Ti₃O₁₀, Cs₂La₂Ti₃O₁₀, CsLa₂Ti₂NbO₁₀, La₂TiO₅, La₂Ti₃O₉, La₂Ti₂O₇, La₂Ti₂O₇, KaLaZr_{0.3} Ti_{0.7}O₄, La₄CaTi₅O₁₇, KTiNbO₅, Na₂Ti₆O₁₃, BaTi₄O₉, Gd₂Ti₂O₇, Y₂Ti₂O₇, ZrO₂, K₄Nb₆O₁₇, Rb₄Nb₆O₁₇, Ca₂Nb₂O₇, Sr₂Nb₂O₇, Ba₅Nb₄O₁₅, NaCa₂Nb₃O₁₀, ZnNb₂O₆, Cs₂Nb₄O₁₁, La₃NbO₇, Ta₂O₅, K₂PrTa₅O₁₅, K₃Ta₃Si₂O₁₃, K₃Ta₃B₂O₁₂, LiTaO₃, NaTaO₃, KTaO₃, AgTaO₃, KTaO₃:Zr, NaTaO₃:La, NaTaO₃, SrNa₂Ta₂O₆, K₂Ta₂O₆, CaTa₂O₆, SrTa₂O₆, BaTa₂O₆, NiTa₂O₆, Rb₄Ta₆O₁₇, Ca₂Ta₂O₇, Sr₂Ta₂O₇, K₂SrTa₂O₇, RbNdTa₂O₇, H₂La_{2/3}Ta₂O₇, K₂Sr_{1.5}Ta₃O₁₀, LiCa₂Ta₃O₁₀, KBa₂Ta₃O₁₀, Sr₅Ta₄O₁₅, Ba₅Ta₄O₁₅, H_{1.8}Sr_{0.81}Bi_{0.19}Ta₂O₇, Mg—Ta Oxide, LaTaO₄, La₃TaO₇, PbWO₄, RbWNbO₆, RbWTaO₆, CeO₂:Sr, BaCeO₃ and a combination thereof. Non-limiting examples of the photocatalyst before modification having visible light absorbing activity may include WO₃, Bi₂WO₆, Bi₂MoO₆, Bi₂Mo₃O₁₂, Zn₃V₂O₈, Na_{0.5}Bi_{1.5}VMoO₈, In₂O₃(ZnO)₃, SrTiO₃:Cr/Sb, SrTiO₃:Ni/Ta, SrTiO₃:Cr/Ta, SrTiO₃:Rh, CaTiO₃:Rh, La₂Ti₂O₇:Cr, La₂Ti₂O₇:Fe, TiO₂:Cr/Sb, TiO₂:Ni/Nb, TiO₂:Rh/Sb, PbMoO₄:Cr, RbPb₂Nb₃O₁₀, PbBi₂Nb₂O₉, BiVO₄, BiCu₂VO₆, BiZn₂VO₆, SnNb₂O₆, AgNbO₃, Ag₃VO₄, AgLi_{1/3}Ti_{2/3}O₂, AgLi_{1/3}Sn_{2/3}O₂ and a combination thereof.

Preferably, the target materials to adsorb to the photocatalyst modified according to the present invention and to be removed are organic materials that can be decomposed by the photocatalyst.

The photocatalyst modified according to the present invention can decompose the materials adsorbed thereto and thus can be used semi-permanently or permanently via light irradiation.

The method of preparing an N-doped photocatalyst via a gas sintering method using high purity ammonia gas according to the second embodiment of the present invention is characterized in that, for the formation of the N-doped photocatalyst with an improved light absorbance in the visible light range of 400 nm to 800 nm, and/or in the infrared region of 800 nm or longer, the flow rate of ammonia gas is adjusted to 50 cm³/min or higher, preferably to 100-200 cm³/min.

Accordingly, the N-doped photocatalyst of the present invention can absorb visible light in the range of 400 nm to 800 nm, infrared light in the range of 800 nm or above, or both types of light, and may take on a green, blue or bluish green color due to N-doping by controlling the flow rate of ammonia gas.

Non-limiting examples of photocatalysts as target substances to be N-doped may include TiO₂, ZnO, Nb₂O₅, WO₃ or a mixture thereof.

The photocatalyst may be a nanoparticle having an average diameter ranging from 1 nm to 100 nm, or be in the form of a film.

An embodiment of the system for N-doping via a gas sintering method is illustrated in FIG. 1. For example, the system is equipped with a high purity ammonia gas supply container, a mass flow controller (MFC), a furnace, and a gas venting line. More specifically, a photocatalyst to be doped is inserted into a reactor and located on the center of a quartz pipe, and heated to a predetermined temperature while supplying ammonia gas at a constant rate using a mass flow controller.

Preferably, the reactor is made of a material such as quartz, ceramic, etc., which are safe under high temperature conditions. Additionally, the height of the reactor preferably has a height that does not prevent the flow of ammonia gas.

The sintering temperature may be in the range of 500° C. to 1000° C., preferably 600° C.

Meanwhile, the method according to the fourth embodiment of the present invention for preparing a modified photocatalyst with an improved adsorption capacity to organic materials, which is decomposed by the photocatalyst, comprises a first step of preparing a photocatalyst with a water-repellent surface containing an organic silicon polymer; and a second step of modifying the water-repellent surface to a hydrophilic surface via oxidation of the organic silicon polymer by heat treatment of the photocatalyst obtained in the first step under vacuum.

Preferably, the photocatalyst as a target substance to be modified is an N-doped photocatalyst, more preferably an N-doped photocatalyst prepared according to the second embodiment of the present invention.

The organic silicon polymer may be a solidified organic silicon polymer, and a non-limiting example of the same may include polydimethylsiloxane (PDMS). PDMS consists of an inorganic backbone of silicon-oxygen repeat units and two methyl groups respectively attached to each silicon atom, and exhibits water-repellency due to the two methyl groups.

The photocatalyst in step 1 may be manufactured via thermal deposition. Specifically, the photocatalyst may be formed by vapor deposition of a water-repellent organic silicon polymer on the photocatalyst surface. The deposition temperature may be in the range of 150° C. to 300° C., and preferably 200° C.

The deposition process may be performed in a sealed container.

Specifically, as shown in FIG. 2(a), the organic silicon polymer and the photocatalyst are added into a round-bottom-flask and sealed with a rubber stopper, and then the reactor is subjected to heat treatment for a predetermined period of time using a temperature controller, a thermocouple, and a voltage controller.

Preferably, the heat-treatment is performed in a sealed container but is not limited thereto. Preferably, the container used therein is selected from the group consisting of containers made of stainless steel, titanium, or an alloy thereof, or a container made of glass, but is not limited thereto. Preferably, the solidified organic silicon polymer such as PDMS has a size of 1 cm³ or less.

Meanwhile, step 2 may be preferably performed under vacuum of 10⁻⁴ Torr or less.

When the water-repellent PDMS-coated layer is subjected to heat treatment under vacuum at a high temperature, the methyl groups in PDMS are oxidized into carbonyl groups, thereby modifying the surface to be a hydrophilic surface.

Step 2 of modifying the water-repellent surface to a hydrophilic surface may be performed in a vacuum heating apparatus equipped with a pressure gauge, a furnace, a rotary pump, and a venting line, as shown in FIG. 2(b). Specifically, a water-repellent photocatalyst is added into the reactor and located on the center of a quartz pipe, and then subjected to heat treatment under vacuum at a high temperature.

The present invention provides not only a coating composition for solar exposure comprising a photocatalyst according to the present invention, but also a formed body for solar exposure coated or formed with the coating composition.

Non-limiting examples of the formed body may include wall papers, tinting films, building materials, glass windows, sound-absorbing walls, road facilities, sign boards, etc. The photocatalyst of the present invention can be attached onto the surfaces of the above formed bodies and remove contaminants while preventing damage thereon by solar light. Additionally, the photocatalyst of the present invention may be used as coating on various exterior or interior materials such as electronic products, transportation means, etc, which could be exposed to the solar light.

Furthermore, the photocatalyst of the present invention may be used to remove organic contaminants.

The organic contaminants may be contaminants present in the air or water. Accordingly, the photocatalyst of the present invention for removing environmental contaminants can be applied in environment-friendly fields such as the removal of volatile organic compounds, air purification, wastewater treatment, and sterilization. Additionally, the photocatalyst of the present invention may be used for the preparation of purified water without contaminants.

### Advantageous Effects

According to the present invention, the surface of TiO₂ with an improved visible light absorbance achieved due to N-doping, when modified using PDMS, a Si—C precursor, to be a hydrophilic surface, exhibited a considerable improvement in removal efficiency of environmental contaminants under visible light irradiation.

Additionally, the photocatalyst of the present invention for removing environmental contaminants can be applied in environment-friendly fields such as the removal of volatile organic compounds, air purification, wastewater treatment, and sterilization, and also remove contaminants by being attached to the surfaces of external walls of buildings, construction materials, glass windows, sound-absorbing walls, road facilities, signboards, etc., while preventing damages by sunlight.

### BRIEF DESCRIPTION OF THE DRAWINGS

FIG. 1 is a diagram showing a nitrogen-doping process for improving the visible light absorbance of TiO₂.

FIG. 2 shows (a) a schematic diagram of an apparatus for hydrophilic surface modification via a water-repellent coating using solidified PDMS; and (b) a schematic diagram of a vacuum heating apparatus for modifying a water-repellent surface to a hydrophilic surface.

FIG. 3A shows the change in visible light absorbance according to variations in the flow rate of ammonia gas. FIG. 3B is a picture showing the change in color of TiO₂ powder according to the flow rate of ammonia gas.

FIG. 4 shows pictures regarding the color change in titanium dioxide (TiO₂), PDMS-coated TiO₂ (PDMS/TiO₂), hydrophilic-modified TiO₂ (h-TiO₂), N-doped TiO₂ (N—TiO₂), PDMS-coated and N-doped TiO₂ (PDMS/N—TiO₂), and N-doped and hydrophilic-modified TiO₂ (h,N—TiO₂) powders (the pictures on the first row from the top), There are the pictures showing that TiO₂ and N-doped TiO₂ powder after being coated with water-repellent PDMS floated on water (the pictures on the second row from the top). Meanwhile, the water contact angles of the sample described above are provided (the tables on the third row and the pictures on the fourth row from the top).

FIG. 5 is a graph showing the removal rate of environmental contaminants of titanium dioxide (TiO₂), N-doped TiO₂ (N—TiO₂), hydrophilic-modified TiO₂ (h-TiO₂), and N-doped and hydrophilic-modified TiO₂ (h,N—TiO₂) under dark conditions and visible light irradiation.

FIG. 6 is a graph showing the visible light absorbance of titanium dioxide (TiO₂), N-doped TiO₂ (N—TiO₂), hydrophilic-modified TiO₂ (h-TiO₂), and N-doped and hydrophilic-modified TiO₂ (h,N—TiO₂)

FIGS. 7A to 7D shows photoelectron spectra on the surfaces of titanium dioxide (TiO₂) and N-doped TiO₂ (N—TiO₂). FIGS. 7A, 7B, 7C, and 7D, respectively correspond to core levels of Ti 2p, O 1s, C 1s, and N 1s.

FIG. 8 shows the results of the infrared spectroscopic analysis of the changes in functional groups after a water-repellent coating on TiO₂ (a) using PDMS (b); hydrophilic surface modification using the same (c); a water-repellent coating on N—TiO₂ (d) using PDMS (e); and hydrophilic surface modification using the same (f).

FIG. 9 shows the results of x-ray diffraction analysis to examine the presence/absence of a phase change in TiO₂ before and after nitrogen doping and hydrophilic surface modification.

### DETAILED DESCRIPTION

Hereinafter, the present invention will be described in more detail with reference to examples. However, these examples are for illustrative purposes only, and the scope of the present invention is not limited to these examples.

### Example 1

### Preparation of TiO₂ Powder with Excellent Removal Efficiency of Environmental Contaminants Under Visible Light Irradiation Due to N-Doping and Hydrophilic Surface Modification

In order to prepare a TiO₂ photocatalyst with an excellent visible light absorbance, N-doped TiO₂ was prepared via a gas sintering method by heating TiO₂ under a constant flow of high purity ammonia gas.

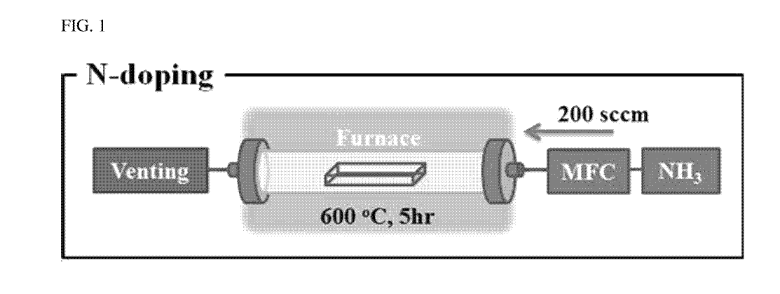

As shown in FIG. 1, in a system equipped with a gas supply container, a mass flow controller, a furnace, and a venting line, 0.5 g of TiO₂ was added into a quartz reactor, centered of the furnace, and then subjected to heat-treatment at 600° C. for 5 hours under a constant flow of high-purity (99.9%) ammonia gas, and thereby prepared N-doped TiO₂. Here, samples were prepared while varying the ammonia gas flow rate to 50 cm³/min, 100 cm³/min, and 200 cm³/min.

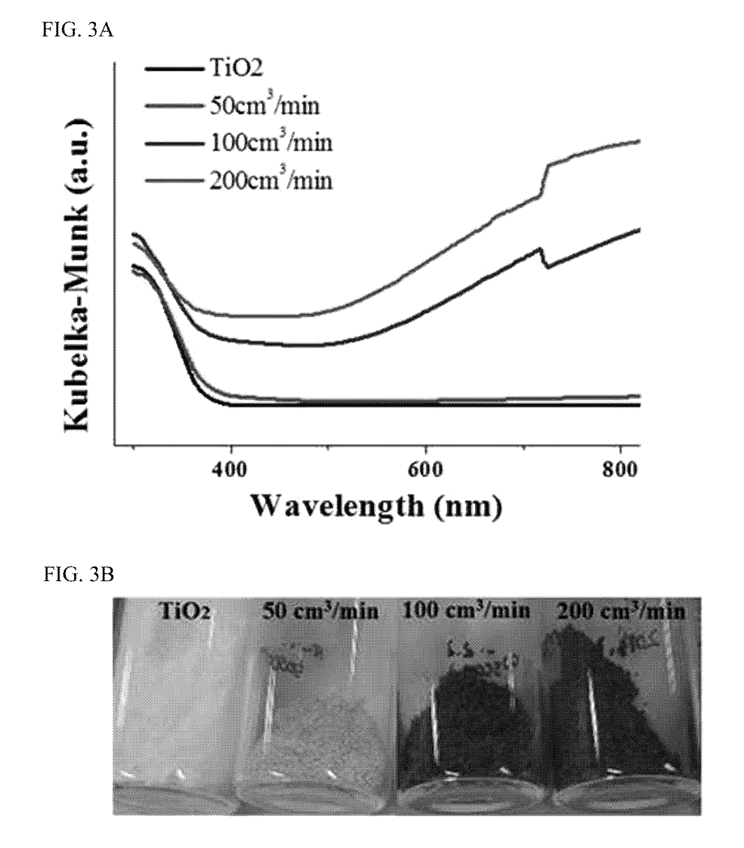

It was confirmed that when white TiO₂ powder was subjected to an ammonia gas flow at a rate of 50 cm³/min it turned to yellow, and as the ammonia gas flow rate increased to 100 cm³/min and 200 cm³/min, the color of the TiO₂ powder turned to a dark green (FIG. 3B). Additionally, based on the visible light absorbance depicted by using diffuse spectrum, it was confirmed that the highest visible light absorbance was obtained at a flow rate of 200 cm³/min (FIG. 3A).

Accordingly, the N-doped TiO₂ surface prepared under ammonia gas flow of 200 cm³/min, which results in the largest increase in of the visible light absorbance, was hydrophilically modified by coating with a water-repellent PDMS via thermal deposition.

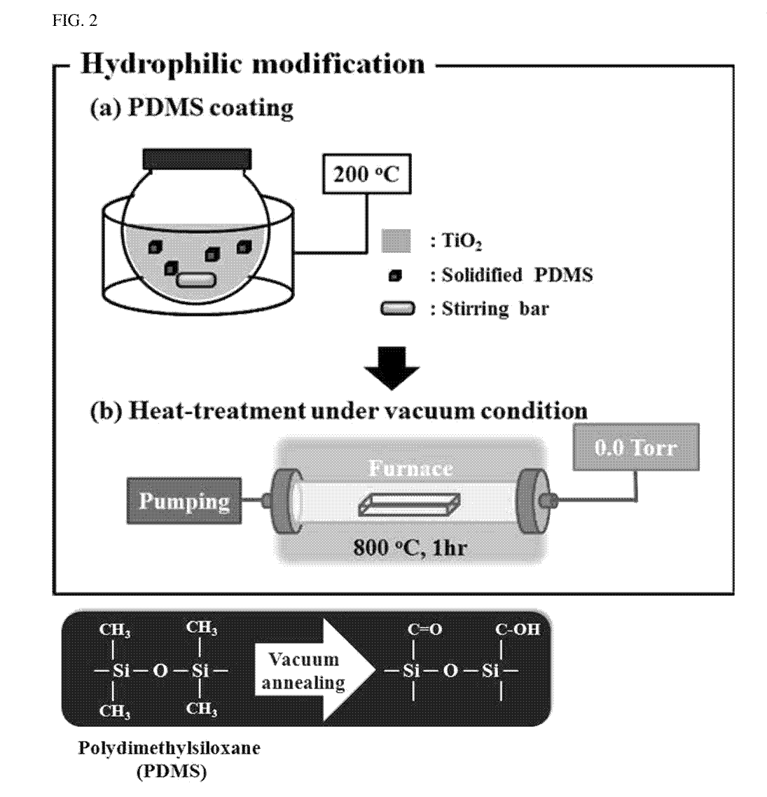

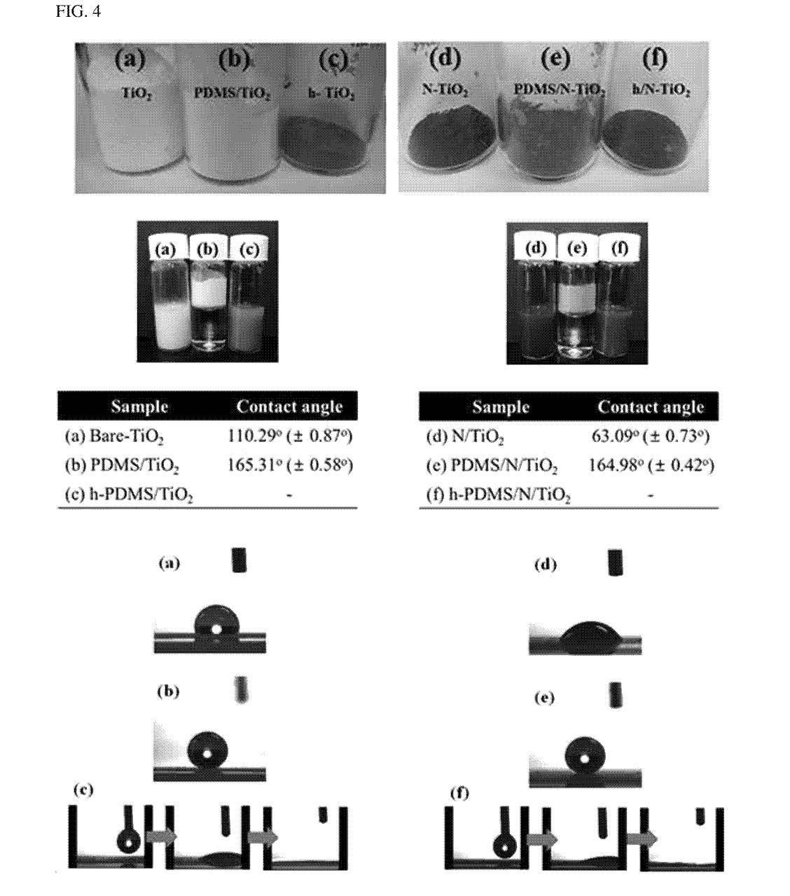

First, as shown in FIG. 2(a), to the reactor was added 4 g of solidified PDMS having a size of 1 cm³ or less and 2 g of the N-doped TiO₂ powder, closed with a rubber stopper, and then heated at 200° C. for 3 hours using a temperature controller, a thermocouple, and a voltage controller. It was confirmed that the bluish green N-doped TiO₂ powder (d) turned to green after the heat-treatment (e) (FIG. 4). When the resultant was added to water and shaken, it floated without being mixed with water, indicating the completion of creation of the water-repellent coating (FIG. 4(e)).

Subsequently, in a vacuum heating apparatus, as shown in FIG. 2(b), equipped with a pressure gauge, a furnace, a rotary pump, and a venting line, 0.5 g of N-doped TiO₂ powder, which exhibits water-repellency due to PDMS coating, was added into a reactor and subjected to heat-treatment at 800° C. for 1 hour under vacuum (10⁻⁴ Torr or below), thereby modifying its surface to a hydrophilic surface. When the resultant was added to water and shaken, it was evenly dispersed in water, it confirmed the modification of the surface from a water-repellent surface to a hydrophilic surface by the heat-treatment under vacuum (FIG. 4(f)).

### Experimental Example 1

### Evaluation of Photocatalyst Activity Via Methylene Blue Decomposition

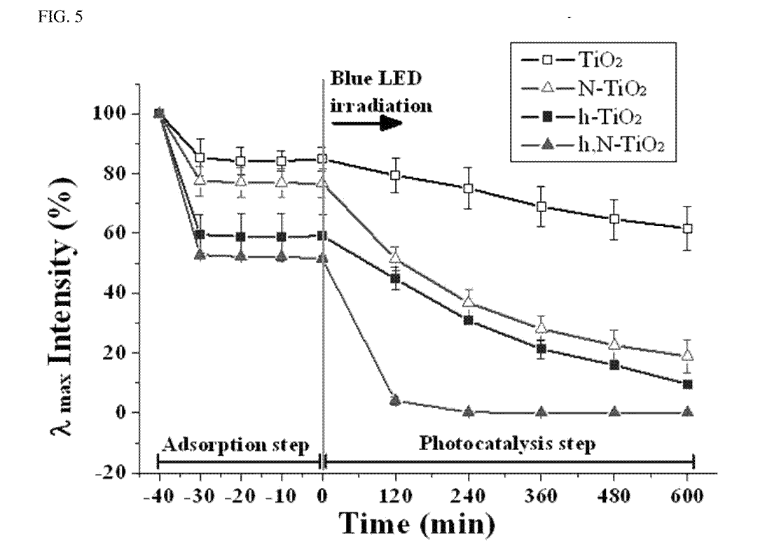

In order to examine the effects of N-doping and hydrophilic surface modification on methylene blue (MB) removal efficiency, experiments for adsorption and photocatalytic decomposition of MB were performed using titanium dioxide (TiO₂), N-doped TiO₂ (N—TiO₂), hydrophilic-modified TiO₂ (h-TiO₂), and N-doped and hydrophilic-modified TiO₂ (h,N—TiO₂) samples (FIG. 5). Specifically, 0.01 g of a photocatalyst sample was dispersed in 50 mL of distilled water by 10-minute of sonication, and 0.1 mL of the photocatalyst sample dispersed in distilled water along with 3.9 mL (1 ppm) of MB solution were added into a plastic cuvette (1×1×4.5 cm³). Experiments were performed using three cuvettes, and the results were indicated via average values and standard deviation.

In order to test the amount of adsorbed MB, the amount of adsorbed MB was tested at 10 minute intervals in dark room conditions, and when the amount of adsorbed MB became constant, the photocatalyst reactivity was tested at two hour intervals under blue LED (λ>450 nm) irradiation having a wavelength range in the visible light region. Since the blue LED used as a light source does not overlap with the light region absorbed by MB, the photocatalyst reactivity may be interpreted as the result of the catalyst alone. The adsorption and the photocatalyst activity were indicated via MB absorbance at maximum absorbance wavelength for absorption spectra using UV-Vis spectrometer (OPTIZEN 3220UV), and the absorbance of MB was measured in the wavelength range of 400 nm to 800 nm.

The amount of MB adsorption was monitored in dark room conditions for 40 minutes at 10 minute intervals and the degree of photocatalyst reactivity was examined for 10 hours at 2 hour intervals. In the case of PDMS-coated TiO₂ (PDMS/TiO₂) and PDMS-coated N-doped TiO₂ (PDMS/N—TiO₂), which were not soluble in water, the tests for adsorption and photocatalyst activity using the aqueous solution of MB could not be performed because of their water insolubility due to water-repellent coating. In dark conditions, TiO₂, N—TiO₂, h-TiO₂, and h,N—TiO₂ showed 15%, 23%, 41%, 48% of MB adsorption rates, respectively. MB adsorption rate was increased about 8% by N-doping and about 25% by hydrophilic surface modification, and therefore, it was confirmed that both N-doping and hydrophilic surface modification increased MB adsorption rate. The above result confirmed that h,N—TiO₂, which was simultaneously applied with both N-doping and hydrophilic surface modification, showed the highest MB adsorption rate of 48%. Based on the above result, it was confirmed that N-doping and hydrophilic surface modification has a synergistic effect on the increase of the MB adsorption rate.

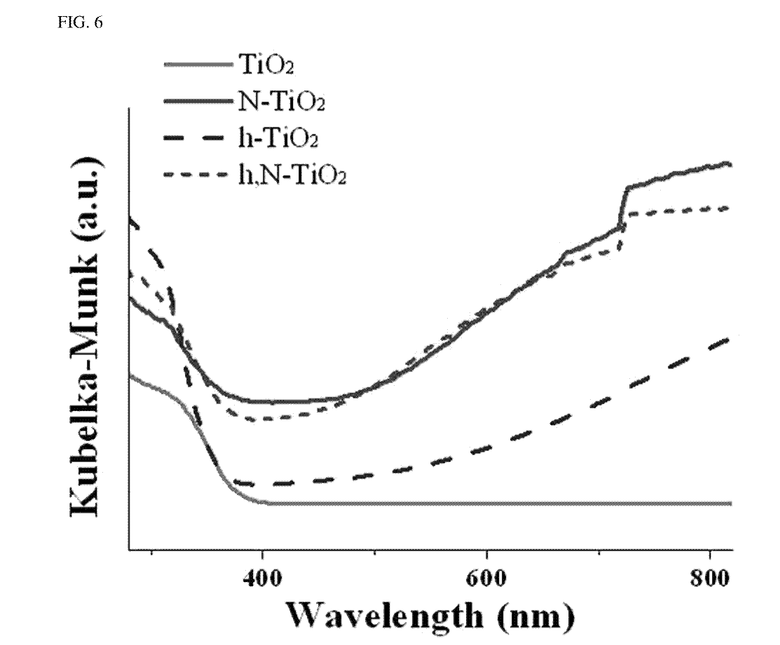

Following the adsorption test in dark conditions, photocatalyst activities under visible light irradiation were compared at 2 hour intervals. The results showed that the photocatalyst activity of N—TiO₂ was considerably improved compared to that of TiO₂. The above result confirmed that N-doping considerably improved the visible light absorbance of TiO₂ and also the photocatalyst activity of TiO₂ under visible light irradiation. Additionally, it was speculated that the 8% increase in MB adsorption rate due to N-doping might have resulted in the increase of photocatalyst activity for MB. In the case of h-TiO₂ with a hydrophilic-modified surface, it has a lower photocatalyst activity than that of N—TiO₂ but has a higher photocatalyst activity than that of TiO₂. In FIG. 6, where the visible light absorbances are shown via diffuse reflection spectra, it was confirmed that the visible light absorbance of TiO₂ increased after hydrophilic surface modification. This is because, in performing a heat-treatment under vacuum after PDMS coating, the methyl group in PDMS is oxidized into a carbonyl group using oxygen within the TiO₂ lattice due to lack of additional oxygen supply source. The formation of oxygen vacancies within the TiO₂ lattice has been known to increase the visible light absorbance of TiO₂ (I, Nakamura et al., J. MOL. CATAL. A-CHEM., 2000). The increase in visible light absorbance due to the formation of oxygen vacancies and the increase in MB adsorption rate due to hydrophilic surface modification resulted in making photocatalyst activity of h-TiO₂ higher than that of TiO₂. However, because the increase in visible light absorbance due to the formation of oxygen vacancies was lower than that due to N-doping (FIG. 6), under visible light irradiation, the photocatalyst activity of N—TiO₂ was superior to that of h-TiO₂. As is the case with the adsorption test, h,N—TiO₂, to which was simultaneously applied both N-doping and hydrophilic surface modification, exhibited the highest photocatalyst activity. This is due to the increase in visible light absorbance by N-doping and the increased MB adsorption rate to 48% as result of N-doping and hydrophilic surface modification. Through the adsorption test in dark conditions and the photocatalyst activity test under visible light irradiation, it was confirmed that both N-doping and hydrophilic surface modification improved the removal efficiency for MB. In particular, N-doping considerably increased photocatalyst efficiency by increasing the visible light absorbance, whereas hydrophilic surface modification considerably increased the amount of adsorbed MB. It was also confirmed that the synergistic effect resulting from the increase in photocatalyst activity due to the increase in the visible light absorbance by N-doping, and the increase in MB adsorption by hydrophilic surface modification, considerably improved the MB removal capability of TiO₂ photocatalyst in the visible light region.

### Experimental Example 2

### Measurement of Changes in Visible Light Absorbance Via Diffuse Reflection Spectra

In order to examine the visible light absorbances of TiO₂, N-doped TiO₂ (N—TiO₂), hydrophilic-modified TiO₂ (h-TiO₂), and N-doped and hydrophilic-modified TiO₂ (h,N—TiO₂), diffuse reflection spectra (SHIMADZU UV-3600) were measured (FIG. 6). The thus measured diffuse reflection spectra were converted into values corresponding to absorbance based on kubelka-munk function. TiO₂ showed absorption capacity in the UV region of below 400 nm wavelength or but showed no absorption capacity in the visible light region of 400 nm or above. However, it was confirmed that N-doped TiO₂ could absorb light in the visible light region of 400 nm or above. Based on the above, it was confirmed that N-doping increased the visible light absorbance of TiO₂. Additionally, it was confirmed that, unlike bare TiO₂, the hydrophilic-modified TiO₂ exhibited absorption of visible light. It is considered that the above is due to the fact that, when the methyl group in PDMS is oxidized into a carbonyl group at high temperature under vacuum conditions, the oxidation proceeds by using oxygen within the TiO₂ lattice due to lack of an additional oxygen supply source. The formation of oxygen vacancies within TiO₂ lattice has been known to increase the visible light absorbance of TiO₂. Additionally, it was also confirmed that the N-doped and hydrophilic-modified TiO₂ exhibited considerably large absorption in the visible light region. Based on the above, it was confirmed that N-doped and hydrophilic surface modified TiO₂ shows increase in visible light absorbance.

### Experimental Example 3

### Confirmation of N-Doping of TiO₂ Via X-Ray Photoelectron Analysis

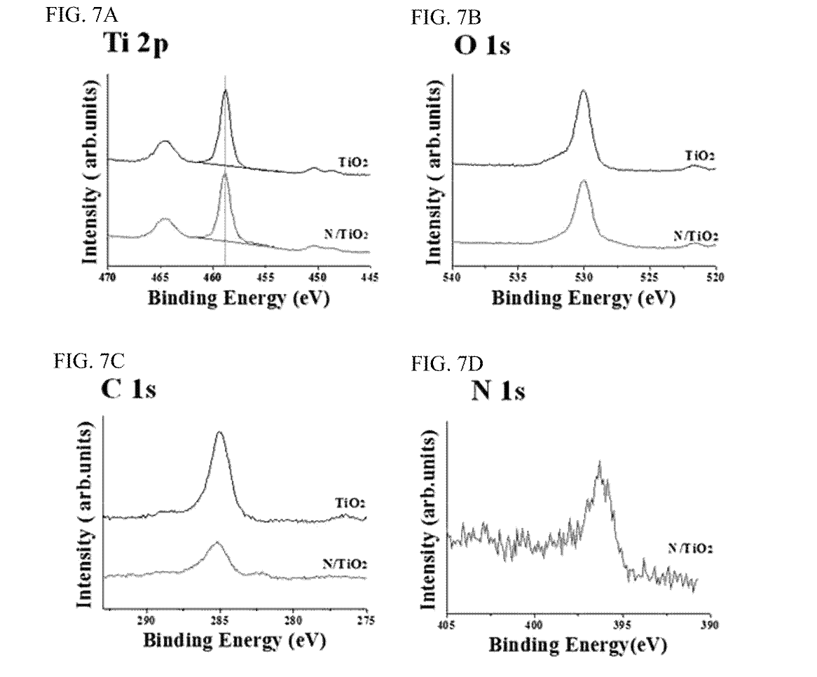

In order to confirm the N-doping of TiO₂, the surfaces of TiO₂ and N-doped TiO₂ (N—TiO₂) were analyzed via x-ray photoelectron analysis using concentric hemisphere analyzer (CHA, PHOIBOSHas 2500, SPECS) and an ultra-high vacuum system (about 3×10⁻¹⁰ Torr) equipped with dual Al/Mg X-ray source (FIGS. 7A to 7D). Samples were prepared into pellets with a diameter of 7 mm and analyzed, and x-ray photoelectron spectra were obtained using Mg/Ka radiation(1253.6 eV) at room temperature. All spectra were normalized with a height of Ti 2p peak. Unlike TiO₂, N 1s peak in N-doped TiO₂ was observed at 396.3 eV. This indicates that nitrogen displaced the oxygen within the TiO₂ lattice (FIG. 7D). Additionally, the main peaks of Ti 2p spectra of bare TiO₂ and N-doped TiO₂ were centered at 458.8 eV, which corresponds to Ti⁴⁺ in the TiO₂ lattice (FIG. 7A). Notably, a shoulder in the Ti 2p spectrum of N-doped TiO₂ was observed at a lower binding energy region, implying that the oxidation number of titanium, which was Ti⁴⁺ within the TiO₂ lattice, was reduced to Ti³⁺, Ti₂⁺, and Ti⁺, after N-doping. This is because when nitrogen replaces oxygen atom within the TiO₂ lattice it serves to form oxygen vacancies. Furthermore, regarding O 1 s and C 1 s peaks, there were no significant changes in their peak positions before and after N-doping (FIGS. 7B and 7C). The C 1s peak at 258 eV indicates impurity carbon on the surface of a catalyst, and the O 1s peak at 530 eV indicates oxygen within the TiO₂ lattice, thus implying that the oxygen within the TiO₂ lattice, even after N-doping, has a chemical environment similar to that before N-doping. It was confirmed that nitrogen was doped on TiO₂ via x-ray photoelectron spectra.

### Experimental Example 4

### Confirmation of PDMS Coating and Hydrophilic Surface Modification Via Infrared Spectroscopy

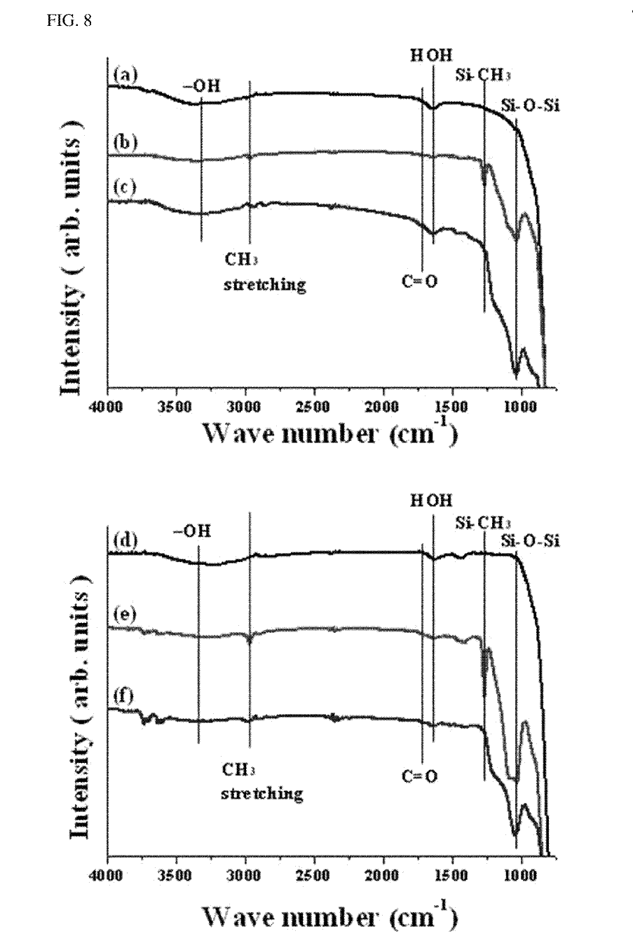

The surfaces of TiO₂ and N-doped TiO₂ after a water-repellent coating using PDMS and hydrophilic modification at a high temperature under vacuum conditions were analyzed via infrared spectroscopy (FIG. 8). Their spectra were obtained in the range of 500 cm⁻¹ to 4000 cm⁻¹ using FT-IR spectrometer (BRUKER, Optics/vertex 70). In the spectra of TiO₂ shown in FIG. 8(a), peaks at 3300 cm⁻¹ and 1630 cm⁻¹ were observed. The peak at 3300 cm⁻¹ represents the ‘-OH’ of TiO₂ surface, whereas the peak of 1630 cm⁻¹ represents its ‘HOH’. The appearances of peaks relating to ‘—OH’ and ‘HOH’ in the spectra for TiO₂ are because TiO₂ originally has a hydrophilic surface. Meanwhile, after the water-repellent PDMS coating (FIG. 8(b)), peaks at 2964 cm⁻¹, 1261 cm⁻¹, and 1100 cm⁻¹ were observed. The peak at 2964 cm⁻¹ represents asymmetric stretching of CH₃, and the peak at 1261 cm⁻¹ represents CH₃—Si. The peak at 1100 cm⁻¹ corresponds to Si—O—Si bond. The above peaks are the peaks of characteristic functional groups for PDMS, and the appearances of the peaks confirmed the PDMS coating. Additionally, the peak intensity of ‘-OH’ at 3300 cm⁻¹ and that of ‘HOH’ at 1630 cm⁻¹ were shown to decrease after PDMS coating, implying that the water-repellent PDMS coating decreased the adsorption between ‘-OH’ on the surface and water. Additionally, in the spectra of TiO₂, where the water-repellent surface coated with PDMS was modified into a hydrophilic surface via heat-treatment under vacuum, shown in FIG. 8(c), the peaks of ‘-CH₃’ and ‘CH₃—Si’ were not observed but only the peak of ‘carbonyl’ was occurred, thus implying that the methyl groups of PDMS which retained water-repellency were converted into carbonyl groups being hydrophilic by the heat-treatment process at a high temperature under vacuum. The appearance of a peak that corresponds to the Si—O—Si bond after the hydrophilic surface modification implies that the lattice structure of PDMS is maintained. Additionally, the peak intensities of ‘-OH’ and ‘HOH’ were shown to increase after the hydrophilic surface modification, thus implying that the water-repellent surface was modified to be even more hydrophilic than the original hydrophilic TiO₂ surface. FIG. 8(d) shows the spectra of N-doped TiO₂, FIG. 8(e) shows the spectra of N-doped TiO₂ after PDMS coating, and FIG. 8(f) shows the spectra of the same after hydrophilic surface modification at high temperature under vacuum. Unlike the change in spectra of TiO₂ before and after hydrophilic surface modification, there was no significant change regarding the peaks of —OH, —CH₃, and carbonyl in the spectra of N-doped TiO₂. However, based on the observation that the Si—CH₃ peak appeared after PDMS coating and then disappeared after heat-treatment under vacuum was confirmed that N-doped TiO₂ was coated with PDMS and then its methyl group exhibiting water-repellency disappeared after heat-treatment under vacuum.

### Experimental Example 5

### Confirmation of Phase-Change of TiO₂ Via x-Ray Diffraction Analysis

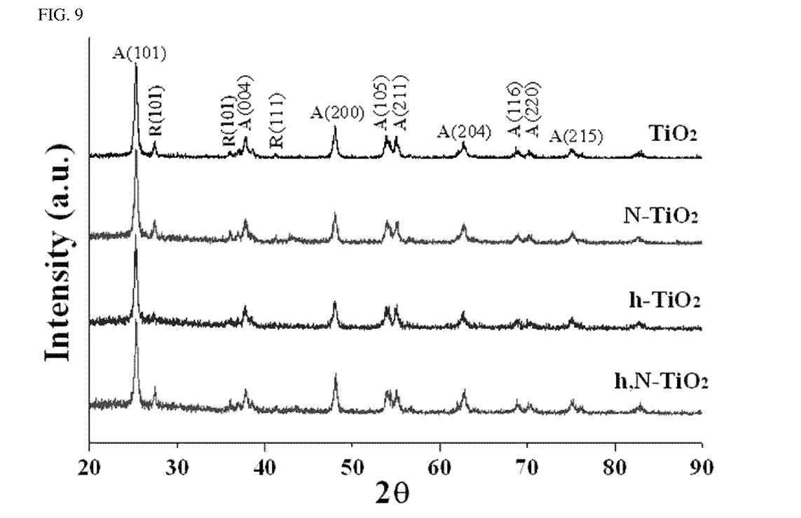

In order to confirm the presence/absence of phase-change of TiO₂ photocatalyst before and after N-doping and surface modification using PDMS, TiO₂, N-doped TiO₂, hydrophilic-modified TiO₂, and N-doped and hydrophilic-modified TiO₂ samples were subjected to x-ray diffraction analysis (RIGAKU, D/MAX-2200 Ultima). Diffraction angles were analyzed in the range of 20° to 80° at a scan speed of 4°/min using Cu Kα radiation (λ=0.15406 nm) as an x-ray source. Based on the x-ray diffraction spectra (FIG. 9), it was confirmed that TiO₂ photocatalyst has an anatase structure and rutile structure. Additionally, it was confirmed that there was no phase-change of TiO₂ before and after N-doping and hydrophilic surface modification

1. A photocatalyst modified by forming a water-repellent coating layer on the surface of a nitrogen (N)-doped photocatalyst with hydrophilic surface modification by an organic silicon polymer and subsequent heat-treating under vacuum via an oxidation of an organic silicon polymer,
wherein the modified photocatalyst allows water molecules to adsorb on the surface thereof and to react with holes, thereby forming hydroxyl radicals.

2. The modified photocatalyst of claim 1, wherein the modified photocatalyst can absorb light in the visible light range of 400 nm to 800 nm, light in the infrared-light region of 800 nm or longer, or both types of light due to nitrogen doping.

3. The modified photocatalyst of claim 1, wherein the modified photocatalyst takes on a green color, a blue color, or a blue-green color due to nitrogen doping.

4. The modified photocatalyst of claim 1, wherein the TiO₂ substituted with nitrogen ions at oxygen position is modified by coating with polydimethylsiloxane (PDMS) and heat-treating under vacuum, thereby forming an oxygen vacancy within the TiO₂ lattice and converting the methyl group of PDMS into a carboxyl group.

5. A method for preparing the N-doped photocatalyst via a gas sintering method using high-purity ammonia gas,
wherein the flow rate of ammonia gas is controlled to be 50 cm³/min or higher,
thereby forming an N-doped photocatalyst with an improved light absorption rate in the visible light range of 400 nm to 800 nm or in the infrared-light region of 800 nm or longer, as compared to that of an N-doped photocatalyst prepared at 50 cm³/min.

6. The method of claim 5, wherein a bluish-colored N-doped photocatalyst is formed by controlling the flow rate of ammonia gas.

7. The method of claim 5, wherein the photocatalyst is TiO₂, ZnO, Nb₂O₅, WO₃ or a mixture thereof.

8. The method of claim 5, wherein the flow rate of ammonia gas is in the range of 100 cm³/min to 200 cm³/min.

9. The method of claim 5, wherein the photocatalyst is a nanoparticle having an average diameter ranging from 1 nm to 100 nm, or is in the form of a film.

10. The method of claim 5, wherein the sintering temperature is in the range of 500° C. to 1000° C.

11. An N-doped photocatalyst prepared by the method of claim 5 and having an improved light absorption rate.

12. The modified photocatalyst of claim 1, wherein the N-doped photocatalyst is prepared by
a method for preparing the N-doped photocatalyst via a gas sintering method using high-purity ammonia gas,
wherein the flow rate of ammonia gas is controlled to be 50 cm³/min or higher,
thereby forming an N-doped photocatalyst with an improved light absorption rate in the visible light range of 400 nm to 800 nm or in the infrared-light region of 800 nm or longer, as compared to that of an N-doped photocatalyst prepared at 50 cm³/min.

13. A method for preparing a modified photocatalyst with an improved adsorption capacity to organic materials, which is decomposed by the photocatalyst, comprising:
a first step of preparing a photocatalyst with a water-repellent surface containing an organic silicon polymer; and
a second step of modifying the water-repellent surface to be a hydrophilic surface via oxidation of the organic silicon polymer by heat treatment of the photocatalyst obtained in the first step under vacuum.

14. The method of claim 13, wherein the photocatalyst obtained in the first step is formed via vapor deposition of the water-repellent organic silicon polymer on the photocatalyst surface.

15. The method of claim 13, wherein the photocatalyst is TiO₂, ZnO, Nb₂O₅, WO₃ or a mixture thereof.

16. The method of claim 13, wherein the photocatalyst is an N-doped photocatalyst.

17. The method of claim 14, wherein the organic silicon polymer is a solidified organic silicon polymer.

18. The method of claim 14, wherein the deposition temperature is in the range of 150° C. to 300° C.

19. The method of claim 14, wherein the deposition is performed in a sealed container.

20. The method of claim 13, wherein the second step is performed under vacuum of 10⁻⁴ Torr or below.

21. A photocatalyst modified by the method of claim 13 to have an improved adsorption capacity to organic materials, which is decomposed by the photocatalyst.

22. A coating composition for solar exposure comprising the photocatalyst of claim 1.

23. A formed body for solar exposure comprising the photocatalyst of claim 1.

24. A method for removing organic contaminants using the photocatalyst of claim 1.

25. A method for preparing purified water comprising a step of removing contaminants in the water using the photocatalyst of claim 1.
